(19) United States
(12) Patent Application Publication
(10) Pub. No.: US 2012/0084294 A1
(43) Pub. Date: Apr. 5, 2012

(54) METHOD AND APPARATUS FOR PROVIDING INDEXING SERVICE IN PORTABLE TERMINAL

(75) Inventors: Seung-Hwa CHO, Busan (KR); Hyun-Chul JUNG, Gyeongsangbuk-do (KR); Jung-Ha SON, Gyeongsangbuk-do (KR); Hee-Song KIM, Gyeongsangbuk-do (KR)

(73) Assignee: SAMSUNG ELECTRONICS CO., LTD., Gyeonggi-Do (KR)

(21) Appl. No.: 13/248,174

(22) Filed: Sep. 29, 2011

(30) Foreign Application Priority Data
Sep. 30, 2010 (KR) 10-2010-0095664

(51) Int. Cl. G06F 17/30

(52) U.S. Cl. 707/741; 707/E17.002

(57) ABSTRACT

Provided is a method and apparatus for providing an indexing service in a portable terminal. The method includes recognizing at least one data selected by a user from a first file provided through a text viewer of the portable terminal and extracting absolute locations of the recognized data in the first file, storing the extracted locations of the data and arranging the data in a predetermined order to create a first sub file related to the first file, and indexing the first file to allow a search in the first file based on particular data by displaying the locations stored for the respective data arranged in the created first sub file. The first sub file is further linked to data from other files according to the data selected by a user so that a user can determine location of a particular data.

### CLAIM OF PRIORITY

This application claims the benefit under 35 U.S.C. §119 of a Korean Patent Application filed in the Korean Intellectual Property Office on Sep. 30, 2010 and assigned Serial No. 10-2010-0095664, the entire disclosure of which is hereby incorporated by reference.

### BACKGROUND OF THE INVENTION

1. Field of the Invention

The present invention generally relates to a portable terminal, and more particularly to a method and apparatus for providing an indexing service in a portable terminal.

2. Description of the Related Art

In the beginning, the function of portable terminals has been limited to voice communication or text transmission. A memory embedded in the portable terminal stores and manages information for supporting these functions, for example, a drive program for driving a system, data related to the program, an address book, a phone directory, a short text message, and the like.

With the recent development of mobile communication and wireless communication technologies, data communication speed has been remarkably improved, thus enabling Internet connection through the portable terminal. The internal memory capacity has also been increased, thus allowing the portable terminal to store a large amount of information therein.

A variety of information stored in the portable terminal, however, are stored in databases having corresponding functions and not shared with each other, thus it can be searched and managed only with the corresponding functions. For example, in case of a high-volume text document file, a table of contents has to be created manually. If too many words are included in the document file, the work load for integrating and indexing the words is in cumbersome and some data change in the document file causes inconvenience associated with repeating the same operation. Moreover, to search for related other information during the use of a particular text document file, a user has to close the currently used text document file, execute another text document file, search for the desired information in the executed text document file, and then go back to the previous closed text document file. As such, the user has to execute a plurality of text document files and check data in each of the text document files in the conventional system.

### SUMMARY OF THE INVENTION

Accordingly, an aspect of the present invention is to provide an apparatus and method for providing an indexing service in a portable terminal, in which locations of data selected by a user from a predetermined file are extracted, stored, and displayed to index the data, and the indexed data are linked to other files, thereby facilitating an access to desired data in a high-volume document file and managing data distributed over a plurality of files in an integrated manner.

According to an aspect of the present invention, there is provided a method for providing an indexing service in a portable terminal. The method includes recognizing at least one data selected by a user from a first file provided through a text viewer of the portable terminal and extracting absolute locations of the recognized data in the first file, storing the extracted locations of the data and arranging the data in a predetermined order to create a first sub file related to the first file, and indexing the first file to allow a search in the first file based on particular data by displaying the locations stored for the respective data arranged in the created first sub file.

According to another aspect of the present invention, there is provided an apparatus for providing an indexing service in a portable terminal. The apparatus includes an indexing unit for indexing a file provided through a text viewer of the portable terminal to allow a search in the file based on particular data, a controller for recognizing at least one data selected by a user from a first file provided through the text viewer of the portable terminal, extracting and storing absolute locations of the recognized data in the first file, arranging the data in a predetermined order to create a first sub file related to the first file, and indexing specific data in the first file by displaying the locations stored for the respective data arranged in the created first sub file, a hyperlink processor for assigning hyperlink entities to the data under the control of the controller, and a database (DB) for managing indexed data of a plurality of files provided through the text viewer in an integrated manner.

According to yet another aspect of the invention, a mobile terminal for providing an indexing service in a portable terminal includes a memory, and a controller recognizing at least one data selected by a user from a first file provided through a display unit, extracting absolute locations of the recognized data in the first file, storing the recognized data according to a predetermined order in a first sub file, and indexing the extracted absolute locations to the recognized data and assigning hyperlinks therebetween, so that a search is possible in the first file based on a particular data.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a flowchart illustrating a method for providing an indexing service in a portable terminal according to an exemplary embodiment of the present invention;

FIG. 2 is diagram illustrating screens for providing an indexing service in a portable terminal according to an exemplary embodiment of the present invention; and

FIG. 3 is a block diagram of an apparatus for providing an indexing service in a portable terminal according to an exemplary embodiment of the present invention.

### DETAILED DESCRIPTION OF THE INVENTION

Hereinafter, an exemplary embodiment of the present invention will be described in detail with reference to the accompanying drawings. In the following description, specific items are described only to provide overall understanding of the present invention. For purposes of simplicity and clarity, detailed descriptions of well-known devices, circuits, and methods are omitted so as not to obscure the description of the present invention with unnecessary detail.

Briefly, the present invention proposes a scheme in which in a Hypertext Markup Language (HTML) markup based file provided through a text viewer of a portable terminal, data, such as proper nouns or important items, a user desires to define are recognized and extracted to display locations thereof and index them through hyperlinks in the file. The extracted locations of the data are stored by assigning hyperlink entities to the data, thus facilitating an access to desired data in a high-volume document file. Thereafter, the indexed data with hyperlinks to other files are further linked to as sub file created in the first file according to predetermined criteria so that the sub file can be used to manage data distributed over a plurality of files in an integrated manner. As a result, a user can efficiently search for data by rapidly finding out a location of the data in a file through a hyperlink given to the data without inputting a separate search word.

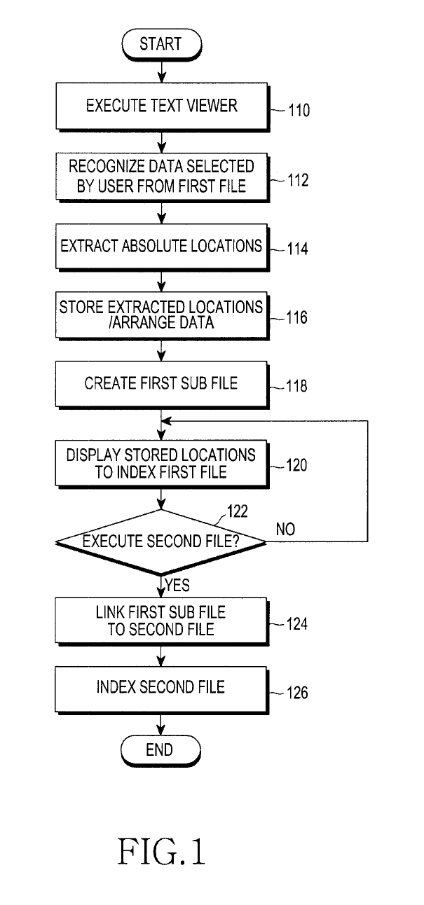

With reference to FIG. 1, a detailed description of above method is provided for providing an indexing service in a portable terminal according to an exemplary embodiment of the present invention.

A portable terminal according to an embodiment of the present invention is preferably a terminal having a text viewer function, which can transmit data over a wired/wireless network. It should be noted a terminal within the context of this disclosure includes other type of information communication devices and multimedia devices, such as a digital broadcasting terminal, a Personal Digital Assistant (PDA), a smart phone, and 3G terminals such as an International Mobile Telecommunication (IMT)-2000 terminal, a Wideband Code Division Multiple Access (WCDMA) terminal, a Global System for Mobile Communication Packet Radio Service (GSM/GPRS) terminal, and a Universal Mobile Telecommunication Service (UMTS) terminal, and applications thereof.

FIG. 1 is a flowchart illustrating a method for providing an indexing service in a portable terminal according to an exemplary embodiment of the present invention.

First, in step 110, a text viewer is executed. Herein, the text viewer refers to a function for viewing contents of a text file, such as a novel, a newspaper, an educational material, etc. transmitted over a wireless network or provided through the portable terminal. Thus, a user can access a plurality of text files by executing the text viewer of the portable terminal.

In step 112, at least one data selected by the user from a first file provided through the executed text viewer are recognized. The data selected by the user are proper nouns included in the file or data for which the user defines addition and deletion. That is, the selected data may be defined in advance, or may be recognized through comparison and searching operations by previously setting data the user desires to add or delete, and linking the data to the first file.

In step 114, absolute locations of the recognized data in the first file are extracted. The absolute location represents a location of data for which is determined a page number that is a criterion for indexing the data in the first file.

In step 116, the extracted locations of the data are stored and the corresponding data are arranged in a predetermined order. The predetermined order may be an English or Korean alphabetical order or a user-defined order, and the extracted locations of the data are stored by assigning hyperlink entities to the data. The hyperlink entities assigned to the data may be used to store the locations of the data by performing hyperlink-processing on the data. To this end, once the hyperlink entities are assigned to the selected data, hyperlinks to the data are automatically created under the control of a controller.

In step 118, the data processed in step 116 are created as a first sub file related to the first file.

In step 120, the locations stored for the respective data arranged in the first sub file created in step 118 are displayed to index the first file such that a search is possible in the first file based on particular data.

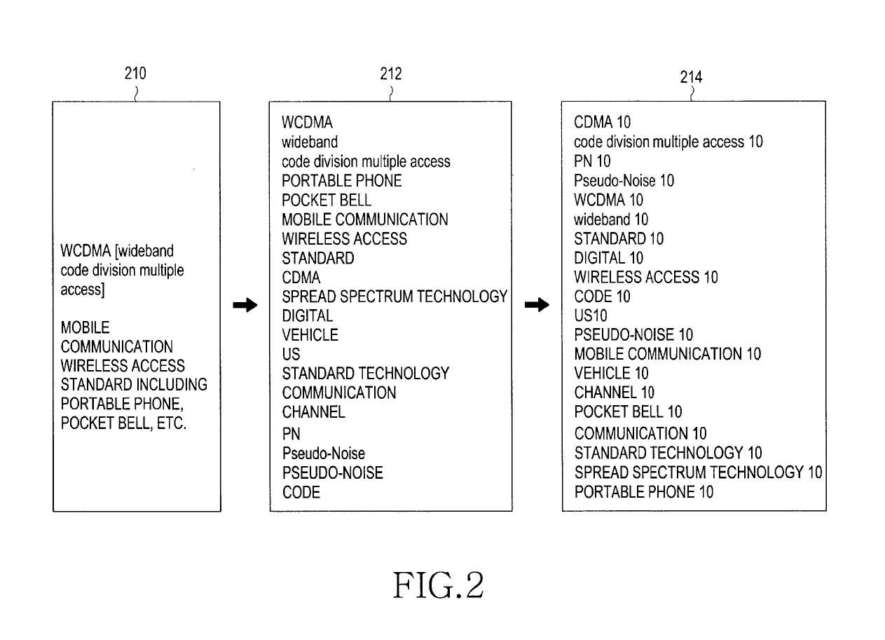

Referring to FIG. 2 to facilitate understanding of steps 110 through 120, (a) of FIG. 2 shows a first file 210 provided through the text viewer of the portable terminal, (b) of FIG. 2 shows a first sub file 212 of the first file 210 in which locations of data selected by the user from the first file 210 and recognized are stored, and the data are arranged in a predetermined order with other data, and (c) of FIG. 2 shows an indexed first sub file 214 in which locations stored for the respective data arranged in the created first sub file 212, that is, page numbers (“10”) are determined and hyperlink entities are assigned to the respective data.

In step 122, it is checked whether a second file that is different from the first file is executed. If the second file is executed, the process goes to step 124 to link the first sub file to the second file.

More specifically, the first sub file created from the first file is applied to the second file to acquire the same data through comparison and searching operations (meaning comparing and searching the first sub file with a second file), and the same processes as in steps 112 through 116 are performed on the acquired data to further add data selected by the user from the second file to the first sub file. Here, the acquired data from the second file is more cumulative so that a user can add/delete some of the data in the second file for a subsequent storage to the first sub file.

In this way, in step 126, the data of the second file are newly added and indexed in the first sub file.

The first sub file created from the first file is updated by using data of other files, for example, the second file, a third file, and the like, such that data included in a plurality of files provided through the text viewer can be indexed in an integrated manner.

A description has been made so far regarding a method for providing an indexing service in a portable terminal according to an exemplary embodiment of the present invention.

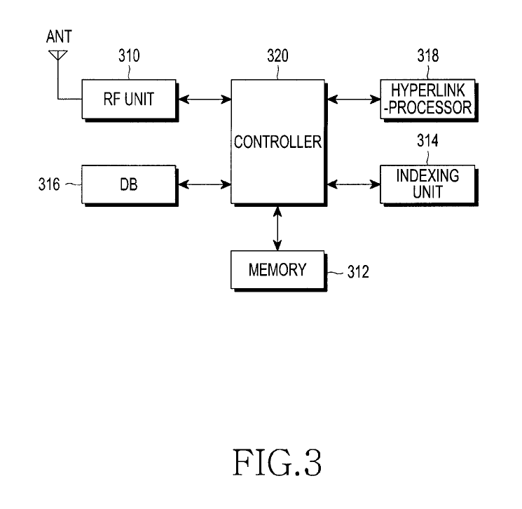

Hereinafter, an apparatus for providing an indexing service in a portable terminal according to an exemplary embodiment of the present invention will be described in detail with reference to FIG. 3.

FIG. 3 is a block diagram of an apparatus for providing an indexing service in a portable terminal according to an exemplary embodiment of the present invention.

Referring to FIG. 3, the apparatus may include a Radio Frequency (RF) communicator 310, a memory 312, an indexing unit 314, a Database (DB) 316, a hyperlink-processor 318, and a controller 320.

In operation, the RF communicator 310 transmits data through Internet or a Wi-Fi wireless network and outputs downlink data acquired by demodulating a radio downlink signal to the controller 320. The RF communicator 310 generates a radio uplink signal by modulating uplink data input from the controller 320 and wirelessly transmits the generated radio uplink signal to the air via an antenna. The modulation and the demodulation may be preferably performed according to Code Division Multiple Access (CDMA), Frequency Division Multiplexing (FDM), or Time Division Multiplexing (TDM).

The memory 312 may store programs for processing and control operations of the controller 320, may function to temporarily store input/output data (for example, a phone book, messages, a media player, a net book , and the like), and may store a plurality of files provided through the text viewer of the portable terminal, and a user-defined dictionary.

The indexing unit 314 performs indexing for a file provided through the text viewer of the portable terminal to allow a search in the file based on particular data under the control of the controller 320.

The controller 320 recognizes at least one data selected by the user from the first file provided through the text viewer of the portable terminal, extracts and stores absolute locations of the recognized data in the first file, arranges the data in a predetermined order to create the first sub file related to the first file, and displays in a display unit (not shown) the locations stored for the respective data arranged in the created first sub file to index particular data in the first file.

The controller 320 links the created first sub file to the second file to index at least one data selected by the user from the second file, such that the first sub file is linked to files different from the first file (i.e., second, third file, etc. in sequence), thereby indexing data of a plurality of files provided through the text viewer in an integrated manner. Note that if the data recognized based on the extracted absolute locations in the first file are changed in the first file, the controller 320 applies the same changes to the indexed data in the first sub file.

The hyperlink-processor 318 applies hyperlinks to the extracted data under the control of the controller 320. In other words, once the controller 320 assigns hyperlink entities to the recognized data, the hyperlink-processor 318 automatically creates hyperlinks by performing hyperlink-processing on the data, thereby storing the locations of the data.

The DB 316 manages indexed data of a plurality of files provided through the text viewer in an integrated manner.

As can be appreciated from the foregoing description, locations of data from a predetermined file are extracted, displayed and arranged to index the data, and the indexed data are linked to other files, thus facilitating an access to desired data in a high-volume document file and managing data distributed over a plurality of files in an integrated manner. As a result, a user can efficiently search for data by rapidly determining a location of the data in the file without inputting a separate search word.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been shown and described with reference to an exemplary embodiment thereof, it will be understood by those skilled in the art that various changes in form and details may be made therein without departing from the spirit and scope of the invention as defined by the appended claims.

What is claimed is:

1. A method for providing an indexing service in a portable terminal, the method comprising:
recognizing at least one data selected by a user from a first file provided through a text viewer of the portable terminal and extracting absolute locations of the recognized data in the first file;
storing the extracted locations of the data and arranging the recognized data in a predetermined order to create a first sub file related to the first file; and
indexing the first file to allow a search in the first file based on a particular data by displaying the locations stored for the respective recognized data arranged in the created first sub file.

2. The method of claim 1, further comprising indexing at least one data selected by the user from a second file to allow a search in the second file based on a particular data by linking the created first sub file to the data selected by the user from second file.

3. The method of claim 1, wherein the storing of the extracted locations of the data comprises assigning hyperlink entities to store the extracted locations of the recognized data.

4. The method of claim 1, wherein if the data recognized based on the extracted absolute locations are changed in the first file, the same changes are applied to the indexed data in the first sub file.

5. The method of claim 1, wherein the data selected by the user are proper nouns included in the file or are selectively added or deleted by the user.

6. The method of claim 1, wherein the first sub file created from the first file is further indexed and linked to data from other files in an integrated manner.

7. An apparatus for providing an indexing service in a portable terminal, comprising:
an indexing unit for indexing a first file provided through a text viewer of the portable terminal to allow a search in the first file based on a particular data;
a controller for recognizing at least one data selected by a user, extracting absolute locations of the recognized data in the first file, storing the recognized data in a predetermined order to create a first sub file related to the first file, and indexing the first file by displaying the locations of the respective data arranged in the created first sub file;
a hyperlink-processor for assigning hyperlink entities to the data stored in the first sub file under the control of the controller; and
a database (DB) for managing indexed data of a plurality of files provided through the text viewer in an integrated manner.

8. The apparatus of claim 7, wherein the controller indexes at least one data selected by the user from a second file to allow a search in the second file based on a particular data by linking the created first sub file to the second file.

9. The apparatus of claim 7, wherein if the data recognized based on the extracted absolute locations are changed in the first file, the controller applies the same changes to the indexed data in the first sub file.

10. The apparatus of claim 7, wherein the controller links the first sub file created from the first file to other files different from the first file by indexing data of the other files provided through the text viewer in an integrated manner.

11. A computer-readable recording medium having recorded thereon a program for executing the method for providing an indexing service in a portable terminal according to claim 1.

12. A mobile terminal for providing an indexing service in a portable terminal, comprising:
a memory;
a controller recognizing at least one data selected by a user from a first file provided through a display unit, extracting absolute locations of the recognized data in the first file, storing the recognized data according to a predetermined order in a first sub file, and indexing the extracted absolute locations to the recognized data and assigning hyperlinks therebetween, so that a search is possible in the first file based on a particular data.

13. The mobile terminal of claim 12, the controller further index at least one data selected by the user from a second file to allow a search in the second file based on a particular data by linking the created first sub file to the second file.

14. The mobile terminal of claim 12, wherein if the data recognized based on the extracted absolute locations are changed in the first file, the same changes are applied to the indexed data in the first sub file.

15. The mobile terminal of claim 12, wherein the data selected by the user are proper nouns included in the first file.

16. The mobile terminal of claim 12, wherein the data selected by the user is selectively added or deleted.

17. The mobile terminal of claim 12, wherein the first sub file created from the first file is further linked to other files.
